(19) United States
(12) Patent Application Publication
(10) Pub. No.: US 2015/0298428 A1
(43) Pub. Date: Oct. 22, 2015

(54) LAYER-TYPE COMPLEX STRUCTURE WITH DECORATION LAYER

(71) Applicant: Ching-Chou Chang, Taichung (TW)

(72) Inventor: Ching-Chou Chang, Taichung (TW)

(21) Appl. No.: 14/256,981

(22) Filed: Apr. 20, 2014

(51) Int. Cl. B32B 7/04; B32B 3/26

(52) U.S. Cl. CPC B32B 7/04; B32B 3/263

(57) ABSTRACT

A layer-type complex structure includes a base layer, a decoration layer fixed to the top surface of the base layer, a cured resin layer attached to the top surface of the decoration layer and a portion of the base layer that is not covered by the decoration layer, and a decoration structure formed on the top surface of the cured resin layer. The decoration layer provides patterns and/or colors displayed on the surface of the complex structure. The decoration structure is a smooth surface or a stereoscopic surface.

### BACKGROUND OF THE INVENTION

1. Fields of the Invention

The present invention relates to a complex structure, and more particularly to a complex structure having a decoration layer.

2. Descriptions of Related Art

The conventional layer-type decoration structure generally comprises two layers, wherein the first layer is the base layer which is made by resin or plastic, and the second layer is the decoration layer which is printed on a surface of the base layer. The base layer is attached to the surface of a product by glue/adhesive. Another conventional layer-type decoration structure generally has only one layer which is coated on a surface of a product by way of printing or spraying.

However, the two conventional layer-type decoration structure cannot show patterns or colors, such as wood patterns or fibers of a natural item, by the printing surface. The layer on the surface of the product can easily be peeled off by friction or other factors.

The present invention intends to provide a complex structure which has three layers including a decoration layer so as to eliminate the shortcomings mentioned above.

### SUMMARY OF THE INVENTION

The present invention relates to a layer-type complex structure which comprises a base layer, a decoration layer fixed to the top surface of the base layer, a cured resin layer attached to the top surface of the decoration layer and a portion of the base layer that is not covered by the decoration layer, and a decoration structure formed on the top surface of the cured resin layer.

Preferably, the base layer is one of releasing material, plastic material and a hard base board.

Preferably, the cured resin layer is composed of 100% solid content Ultra-Violet-ray cured resin.

Preferably, the decoration layer is made of a plate which is made from natural objects, or an artificial plate. The natural objects can be one of animal leathers, plant leaves and wood chips. The artificial plate can be one of weaved fabrics, carbon-weaved fabrics, glass-fiber weaved fabrics and printing fabrics.

Preferably, the decoration structure is a smooth surface or a stereoscopic surface.

The primary object of the present invention is to provide a layer-type complex structure which comprises three layers, wherein the decoration layer displays specific patterns and/or colors not by way of printing. The decoration layer shows the shapes, patterns and colors of natural or artificial objects.

The cured resin layer protects and fixes the decoration layer so that eh decoration layer is not peeled off or separated from the base layer.

The decoration structure is a smooth surface or a stereoscopic surface to provide different touches.

The present invention will become more obvious from the following description when taken in conjunction with the accompanying drawings, which show, for purposes of illustration only, a preferred embodiment in accordance with the present invention.

### BRIEF DESCRIPTION OF THE DRAWINGS

FIG. 1 is a cross sectional view of the first embodiment of the complex structure of the present invention;

FIG. 2 is a cross sectional view of the second embodiment of the complex structure of the present invention;

FIG. 3 is a perspective view of the first embodiment of the complex structure of the present invention;

FIG. 4 is a perspective view of the second embodiment of the complex structure of the present invention, and

FIG. 5 shows the steps of the formation of the complex structure of the present invention.

### DETAILED DESCRIPTION OF THE PREFERRED EMBODIMENT

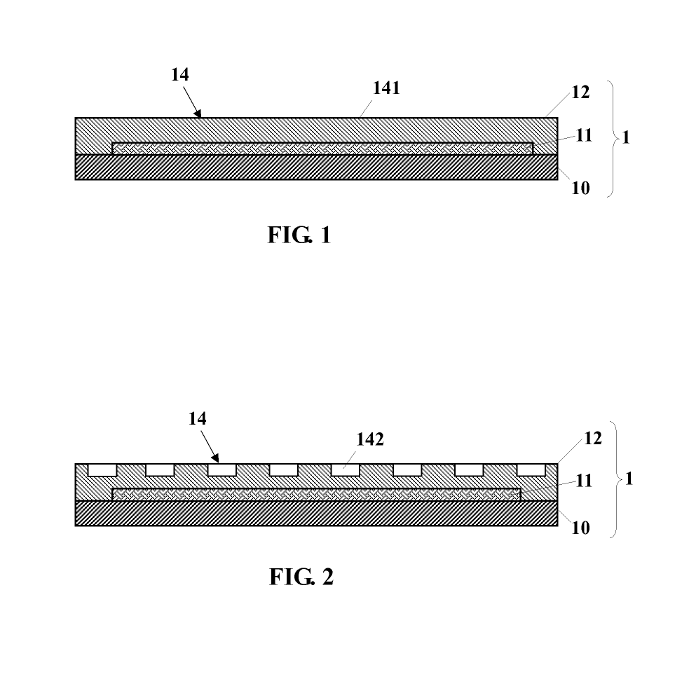

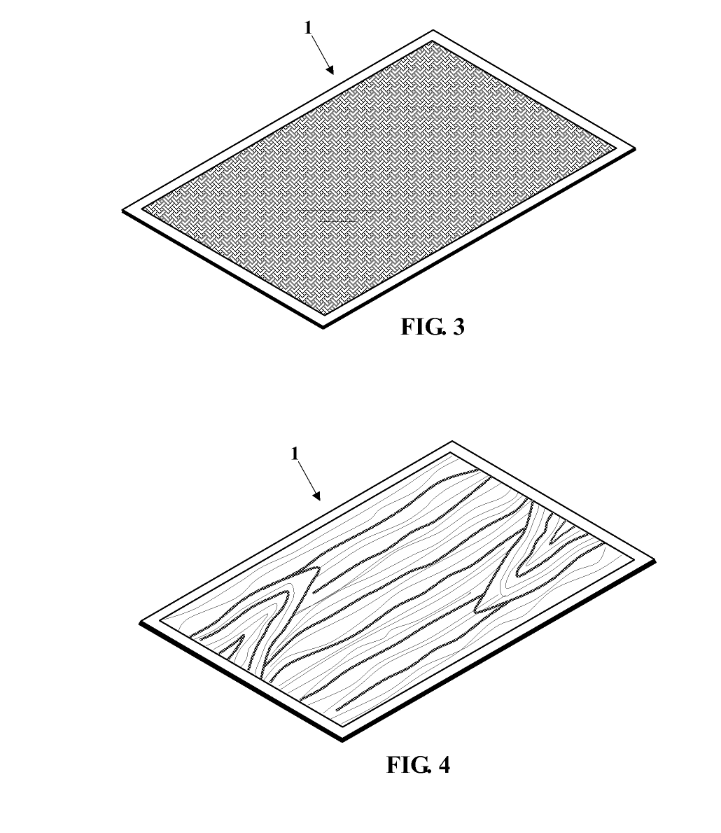

Referring to FIGS. 1 to 4, the complex structure of the present invention comprises a base layer 10, a decoration layer 11 fixed to the top surface of the base layer 10, a cured resin layer 12 attached to the top surface of the decoration layer 11 and a portion of the base layer 10 that is not covered by the decoration layer 11, and a decoration structure 14 formed on the top surface of the cured resin layer 12.

The base layer 10 is one of releasing material, plastic material (such as Polyethylene Terephthalate PET) and a hard base board.

The cured resin layer 12 is composed of 100% solid content Ultra-Violet-ray cured resin 121.

The decoration layer 11 is made of a plate which is made by natural objects such as animal leathers, plant leaves or wood chips.

The decoration layer 11 is an artificial plate which can be one of weaved fabrics, carbon-weaved fabrics and glass-fiber weaved fabrics.

The decoration structure 14 is a smooth surface or a stereoscopic surface 142.

The decoration layer 11 displays specific patterns and/or colors not by way of printing. The decoration structure is a smooth surface or a stereoscopic surface.

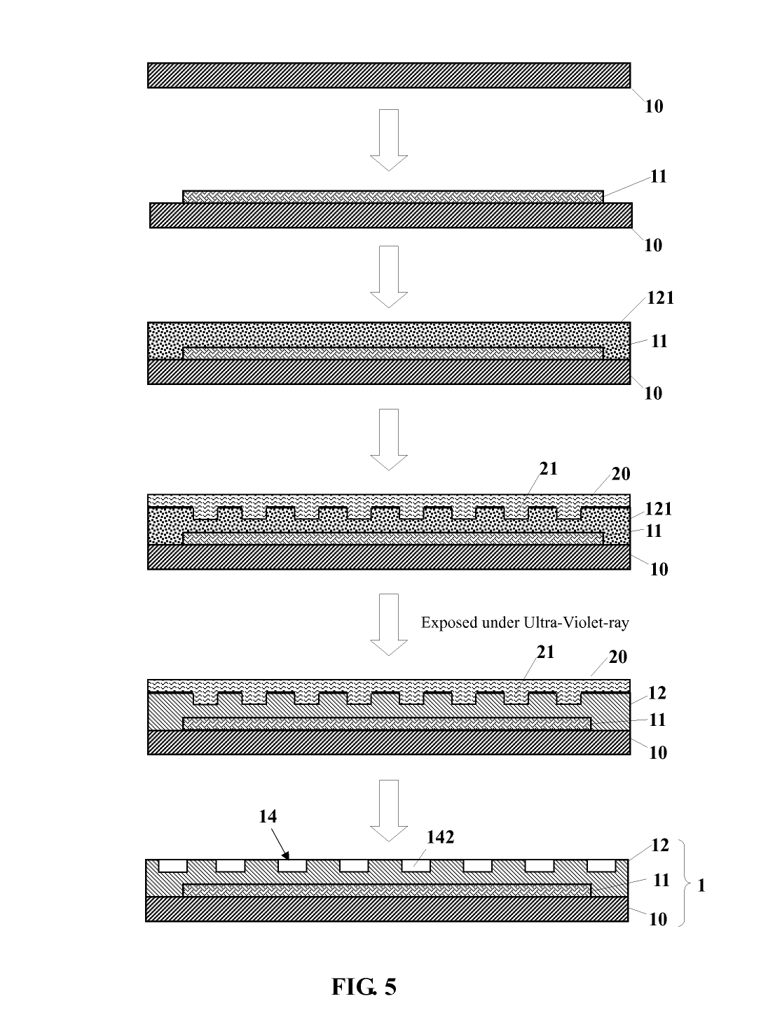

FIG. 5 shows the steps of the formation of the complex structure 1 of the present invention. The base layer 10 is first prepared and the decoration layer 11 is connected to the base layer 10. The 100% solid content Ultra-Violet-ray cured resin 121 is then sprayed on the top surface of the base layer 10 and the decoration layer 11 with a pre-set thickness. The 100% solid content Ultra-Violet-ray cured resin 121 will be merged into the decoration layer 11 and attached to the top surface of the base layer 10. The releasing material 20 is coated to the top surface of the 100% solid content Ultra-Violet-ray cured resin 121, wherein the releasing material 20 allows Ultra-Violet-ray to pass through. The releasing material 20 has a transfer printing structure 21 on the surface thereof and the transfer printing structure 21 can be a smooth surface or a stereoscopic surface. The transfer printing structure 21 is in contact with the top surface of the 100% solid content Ultra-Violet-ray cured resin 121 so that the surface of the 100% solid content Ultra-Violet-ray cured resin 121 is formed into a desired status according to the transfer printing structure 21. Eventually, the layered complex is exposed under the Ultra-Violet-ray which passes through the releasing material 20 to cure the 100% solid content Ultra-Violet-ray cured resin 121. After the 100% solid content Ultra-Violet-ray cured resin 121 is cured, the releasing material 20 is removed, the 100% solid content Ultra-Violet-ray cured resin 121 is fixed to the surface of the base layer 10 and the decoration layer 11 to form the above mentioned cured resin layer 12 which has the decoration structure 14 which is formed according to the transfer printing structure 21. The decoration structure 14 may be a smooth surface or a stereoscopic surface.

While we have shown and described the embodiment in accordance with the present invention, it should be clear to those skilled in the art that further embodiments may be made without departing from the scope of the present invention.

What is claimed is:

1. A layer-type complex structure comprising:
a base layer;
a decoration layer fixed to a top surface of the base layer;
a cured resin layer attached to a top surface of the decoration layer and a portion of the top surface of the base layer that is not covered by the decoration layer;
the decoration layer having a thickness smaller than that of the cured resin layer, and
a decoration structure formed on a top surface of the cured resin layer.

2. The layer-type complex structure as claimed in claim 1, wherein the base layer is one of releasing material, plastic material and a hard base board.

3. The layer-type complex structure as claimed in claim 1, wherein the cured resin layer is composed of 100% solid content Ultra-Violet-ray cured resin.

4. The layer-type complex structure as claimed in claim 1, wherein the decoration layer is made of a plate which is made from natural objects.

5. The layer-type complex structure as claimed in claim 4, wherein the decoration layer is one of animal leathers, plant leaves and wood chips.

6. The layer-type complex structure as claimed in claim 1, wherein the decoration layer is an artificial plate.

7. The layer-type complex structure as claimed in claim 6, wherein the decoration layer is one of weaved fabrics, carbon-weaved fabrics and glass-fiber weaved fabrics.

8. The layer-type complex structure as claimed in claim 1, wherein the decoration structure is a smooth surface.

9. The layer-type complex structure as claimed in claim 1, wherein the decoration structure is a stereoscopic surface.
